(19) United States
(12) Patent Application Publication
(10) Pub. No.: US 2018/0290615 A1
(43) Pub. Date: Oct. 11, 2018

(54) MULTI-CHAMBER AIRBAGS AND ASSOCIATED METHODS OF MANUFACTURE AND USE

(71) Applicant: AmSafe, Inc., Phoenix, AZ (US)

(72) Inventor: Todd Joseph Humbert, Chandler, AZ (US)

(21) Appl. No.: 16/006,742

(22) Filed: Jun. 12, 2018

Related U.S. Application Data
(62) Division of application No. 15/398,977, filed on Jan. 5, 2017.
(60) Provisional application No. 62/292,642, filed on Feb. 8, 2016.

(51) Int. Cl. B60R 21/18; B60R 21/233; B64D 11/06; B60R 21/00; B60R 21/2338; B60R 21/231

(52) U.S. Cl. CPC B60R 21/18; B60R 21/233; B64D 11/06205; B60R 2021/23308; B60R 2021/23115; B60R 2021/0044; B60R 2021/23386; B64D 2201/00; B60R 2021/0093

(57) ABSTRACT

Multi-chamber airbag systems for use in aircraft and other vehicles are described herein. In some embodiments, an occupant restraint system includes a multi-chamber airbag that deploys from an occupant restraint (e.g., a lap seat belt) in an aircraft. The multi-chamber airbag can include a first portion that inflates generally upward in front of the occupant's torso, and a second portion that inflates in front of the first portion. The first portion and/or the second portion can include multiple chambers (e.g., generally cylindrical-shaped chambers) that, when inflated, provide the airbag with a shape and/or contact surfaces which can help to maintain the position of the airbag between the occupant and a strike object or hazard. In other embodiments, multi-chamber airbags configured in accordance with the present disclosure can me mounted to a structure (e.g., a monument, console, seat back, etc.) positioned generally in front of the occupant. The structure-mounted airbag can deploy generally toward the occupant in the event of a vehicle impact or other potentially harmful event to protect the occupant from impact injury.

### CROSS-REFERENCE TO APPLICATIONS INCORPORATED BY REFERENCE

This application is a divisional of U.S. patent application Ser. No. 15/398,977, filed Jan. 5, 2017, which claims priority to and the benefit of U.S. Provisional Patent Application No. 62/292,642, filed Feb. 8, 2016, the disclosures of which are incorporated herein by reference in their entireties.

### TECHNICAL FIELD

The following disclosure relates generally to occupant restraint systems for use in aircraft and other vehicles and, more particularly, to occupant restraint systems having airbags.

### BACKGROUND

Airbags can protect occupants from strike hazards in automobiles, aircraft, and other vehicles. In automobiles, for example, airbags can be stowed in the steering column, dashboard, side panel, or other location. In the event of a collision or other dynamic event of sufficient magnitude, a sensor detects the event and transmits a corresponding signal to an initiation device (e.g., a pyrotechnic device) on an airbag inflator. This causes the inflator to release compressed gas into the airbag, rapidly inflating the airbag and deploying it in front of the driver or other occupant to cushion their impact with forward objects.

Some aircraft also include airbags for occupant safety. For example, some aircraft include airbags that are carried on lap seat belts which can be secured around an occupant's waist in a conventional manner. The airbag is typically stowed under a removable cover on the seat belt. In the event the aircraft experiences a forward impact or other significant dynamic event, the airbag immediately inflates, displacing the cover and rapidly deploying upward in front of the occupant to create a cushioning barrier between the occupant and a seat back, partition, monument, or other structure in the seating area.

Conventional seat belt-mounted airbags in aircraft typically include a single chamber that fills with air to form a protective barrier between the occupant and a strike hazard. When this type of airbag inflates, the internal air pressure typically forms the airbag into a generally cylindrical shape. In some instances, this can cause the airbag to deflect off of a strike hazard, especially if the strike hazard is positioned at an oblique angle relative to the occupant seat. This can reduce the effectiveness of the airbag. Additionally, in some situations the cylindrical shape of the airbag may cause the occupant's head to deflect off of the airbag to one side or the other, potentially putting undue stress on the occupant's neck. Accordingly, it would be advantageous to provide an airbag that addresses these issues.

### BRIEF DESCRIPTION OF THE DRAWINGS

FIG. 1A is a front isometric view of a vehicle occupant secured in a seat by a restraint system having a multi-chamber airbag configured in accordance with an embodiment of the present technology, and FIG. 1B is a similar isometric view of the vehicle occupant after the airbag has been deployed.

FIGS. 2A-2D are a series of front isometric, rear isometric, front, and side views, respectively, of the multi-chamber air bag of FIG. 1B.

FIG. 3 is a cross-sectional top view of the airbag taken substantially along line 3-3 in FIG. 2C.

FIGS. 4A-4C are a series of cross-sectional front isometric views of the airbag taken substantially along lines 4A-4A, 4B-4B, and 4C-4C, respectively, in FIG. 2D.

FIG. 5 is a front isometric view of a vehicle occupant secured in a seat by a restraint system having a multi-chamber airbag configured in accordance with another embodiment of the present technology.

FIG. 6A is a rear isometric view of the airbag of FIG. 5, FIG. 6B is a side cross-sectional, rear isometric view of the airbag taken substantially along line 6B-6B in FIG. 6A, and FIG. 6C is a top cross-sectional, rear isometric view of the airbag taken substantially along line 6C-6C in FIG. 6A.

FIG. 7 is a partially schematic isometric view of a seat belt airbag system configured in accordance with an embodiment of the present technology.

FIG. 8 is a top isometric view of a seat belt-mounted multi-chamber airbag configured in accordance with an embodiment of the present technology deployed in an aircraft seating area with an oblique seating arrangement.

FIG. 9A is a side isometric view of an aircraft seating area having a structure-mounted multi-chamber airbag configured in accordance with an embodiment of the present technology, and FIGS. 9B and 9C are side and top isometric views, respectively, of the structure-mounted multi-chamber airbag deployed in the seating area.

FIGS. 10A-10F are a series of plan views illustrating materials and processes for manufacturing a multi-chamber airbag having an active vent configured in accordance with an embodiment of the present technology.

FIGS. 11A and 11B are partially schematic top views illustrating operation of a multi-chamber airbag having an active vent in accordance with an embodiment of the present technology.

### DETAILED DESCRIPTION

The following disclosure describes various embodiments of airbags that have multiple chambers that inflate and deploy in front of a seat occupant to provide a cushioning barrier between the occupant and, e.g., a forward structure. In some embodiments, the multi-chamber airbags described herein can be neatly stowed and carried on the webbing of a lap seat belt in an aircraft. A gas hose extends from the stowed airbag to an inflator that can be mounted under the seat or in another suitable location. If the aircraft experiences an accident or other significant dynamic event (e.g., a rapid deceleration) in which the occupant could be thrown forward against an object or structure, an electronic sensing system activates the inflator which rapidly releases compressed gas into the airbag via the gas hose, causing the airbag to rapidly inflate and deploy from the seat belt in front of the occupant. In other embodiments, the multi-chamber airbags described herein can be mounted to a structure (e.g., a monument, partition, seatback, etc.) positioned generally in front of the seated occupant and/or generally in the direction the occupant's body would move in response to a forward impact. In these embodiments, an inflator for inflating the airbag in response to a crash or other significant dynamic event can be positioned in the mounting structure or in another convenient location and connected to the airbag via a gas hose or other means of fluid communication. If the aircraft experiences an impact or other dynamic event above a preset threshold, an electronic sensing system activates the inflator which inflates and deploys the airbag outwardly from the structure to provide a cushion and protect the occupant from striking the structure. In addition to the features described above, embodiments of the airbag systems described herein can also include various types of active vent systems to rapidly deflate the airbag after deployment and reduce occupant rebound. For example, in some embodiments the active vent system can include a second inflator for rapidly opening a vent in the airbag very shortly after inflation. The vent can include, for example, a piece material (e.g. a panel of the airbag) that is secured by stitching that is ruptured by inflation of an air hose coupled to the second inflator. Further aspects of the embodiments of the present disclosure are described in detail below.

As described in greater detail below, in some embodiments the multi-chamber airbags described herein can be carried on a lap seat belt and deployed directly in front of the seat occupant. In some embodiments, the airbag can include a first airbag portion that is directly attached to the seat belt and deploys directly in front of the occupant, and a second airbag portion that inflates directly in front of the first airbag portion. For ease of reference, the first airbag portion can be referred to as a “torso airbag” or a “rear airbag portion,” and the second airbag portion can be referred to as a “front airbag portion.” As described in greater detail below, in some embodiments each of the front and rear airbag portions can include two or more chambers. For example, the rear airbag portion can include two separate chambers that, when inflated, are generally cylindrical in cross-sectional shape and extend generally vertically in a side-by-side arrangement in front of the seat occupant. Similarly, the front airbag portion can also include two separate chambers having generally cylindrical cross-sections positioned side-by-side and extending generally vertically in front of the rear airbag portion. In other embodiments, the front or rear airbag portion may include only a single chamber. For example, in some embodiments the rear airbag portion can include a single chamber, and the front airbag portion can include two chambers having generally cylindrical cross-sections positioned side-by-side and extending generally vertically in front of the rear airbag portion. In further embodiments, the rear airbag portion can include two chambers and the front airbag portion can have a single chamber. In still further embodiments, the front and/or rear airbag portions can include two or more chambers (e.g., three chambers, etc.), and the chambers can have various arrangements (e.g., vertical, horizontal, side-by-side, stacked top-to-bottom, etc.) without departing from the scope of the present disclosure.

As described in greater detail below, embodiments of the multi-chamber airbag systems described herein can address some of the issues associated with conventional airbags by providing an airbag shape and corresponding contact surfaces which can help to “square up” (e.g., align) the airbag to the occupant's torso on contact, thereby reducing the likelihood that the occupant's head will deflect off the airbag to one side or the other. Additionally, the use of multiple chambers for, e.g., the front airbag portion can also provide a favorable airbag surface (e.g., a generally flat surface, or a surface of multiple contact points) for making contact with a forward strike hazard, thereby reducing deflection of the airbag off of the strike hazard and/or rebound of the occupant upon airbag impact with the strike hazard.

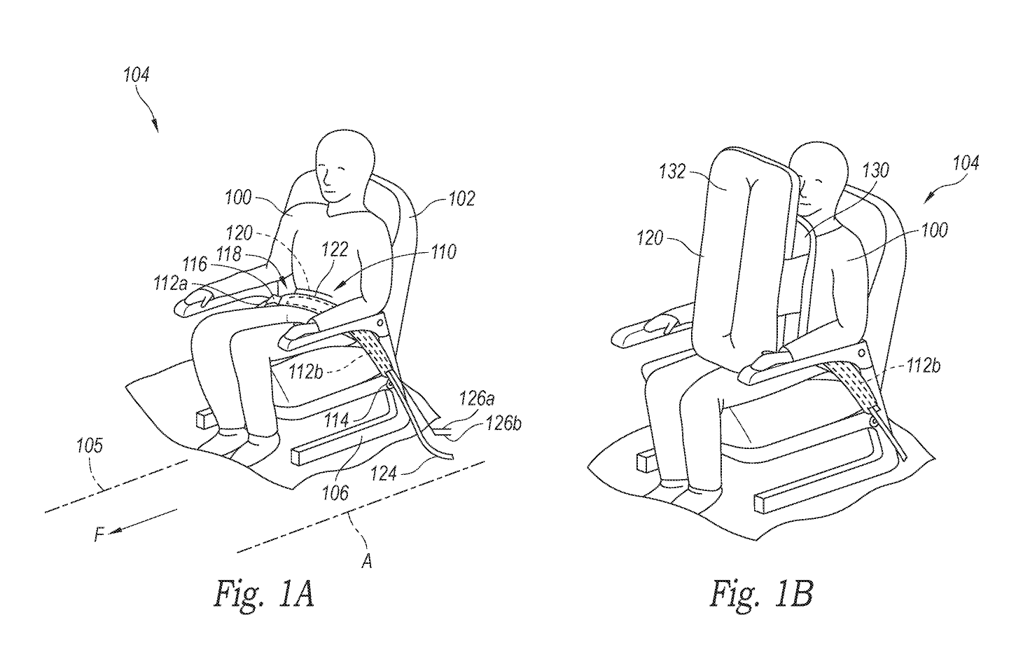

Certain details are set forth in the following description and in FIGS. 1A-10B to provide a thorough understanding of various embodiments of the present technology. In other instances, other details describing well-known structures, materials, methods and/or systems often associated with airbags, airbag inflation systems and related circuitry, seat belts, aircraft interior structures, etc. in aircraft and other vehicles are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention. Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1A is a front isometric view of a seat occupant 100 (e.g., a passenger) secured in a seat 102 by a restraint system 110 configured in accordance with an embodiment of the present technology. In the illustrated embodiment, the seat 102 is positioned in an aircraft seating area 104, such as in a passenger cabin of a commercial or private aircraft. For example, the seat 102 can be at least generally similar to a conventional seat in, for example, a first or business class cabin of a commercial passenger aircraft. In the illustrated embodiment, the seat 102 faces forward, or at least generally forward, in direction F toward the front of the aircraft. Accordingly, in this embodiment a centerline 105 of the seat 102 extends parallel to, or at least approximately parallel to, a longitudinal axis A of the aircraft (e.g., a longitudinal axis of the aircraft fuselage). (It should be understood that the longitudinal axis A could also represent the centerline of the aircraft). In other embodiments, the seat 102 can positioned so that the occupant 100 faces generally forward, but with the seat centerline 105 oriented at an angle relative to the longitudinal axis A. For example, the seat centerline 105 can be positioned at angles of from about 5 degrees to about 90 degrees, or from about 10 degrees to about 45 degrees, relative to the longitudinal axis A. In further embodiments, the seat 102 can be positioned in other orientations and/or other settings. Additionally, as those of ordinary skill in the art will appreciate, although only one seat 102 is illustrated in FIG. 1A, in other embodiments additional seats can be positioned to one or both sides of the seat 102 to comprise a row of seats.

The restraint systems described herein can be used to protect occupants in a wide variety of vehicles, including other types of aircraft (e.g., both fixed- and rotary-wing aircraft), land vehicles (e.g., automobiles), watercraft, etc., and with a wide variety of seating arrangements and orientations, such as center aisle seats, outer aisle seats, seats positioned directly behind other seats, monuments, walls, partitions, consoles, closets, etc., “infinite setback seats” (seats that are not positioned behind other structures), and seats in other orientations relative to, for example, the forward end of the aircraft and/or the direction F of forward travel, such as side facing seats, or seats oriented at other angles relative to the longitudinal axis A of the aircraft.

In the illustrated embodiment, the restraint system 110 includes a lap seat belt 118 (which can also be referred to as a “two-point restraint”) having a first web portion 112a and a second web portion 112b. The web portions 112a, b can be at least generally similar in structure and function to conventional seat belt webbing comprised of, for example, woven nylon, woven polyester, etc. A proximal end of the second web portion 112b is fixedly attached to a seat frame 106 on one side of the occupant 100 by an attachment fitting 114, and a proximal end of the first web portion 112a is similarly attached to the seat frame 106 on the opposite side of the occupant 100. A distal end of the first web portion 112a carries a buckle 116 that is configured to receive and releaseably engage a corresponding web connector tongue (not shown in FIG. 1A) attached to the distal end of the second web portion 112b. In operation, the occupant 100 secures the seat belt 118 around his or her waist in a conventional manner. More specifically, after sitting in the seat 102, the occupant can insert the connector tongue on the second web portion 112b into the buckle 116 and adjust the tension in the seat belt 118 in a conventional manner. To release the seat belt 118, the occupant 100 lifts a handle on the buckle 116 or otherwise releases the connector tongue from the buckle 116 in a conventional manner.

The restraint system 110 further includes an airbag 120 that is operably attached to the second web portion 112b of the seat belt 118. Prior to use, the airbag 120 is folded and stowed under a flexible cover 122 which encloses the airbag 120 and can wrap around the second web portion 112b. A gas hose 124 extends from the airbag 120 and is operably coupled in fluid communication with an airbag inflator (not shown in FIG. 1A). Additionally, in some embodiments a first wire 126a and a second wire 126b can be routed under the cover 122 to a seat belt switch (not shown) that completes a circuit or is otherwise operable to indicate when the connector tongue on the second web portion 112b is properly coupled to the buckle 116, which can be a precondition for deployment of the airbag 120. As described in greater detail below, upon inflation in response to, for example, a rapid deceleration of the aircraft or other accident scenario, the inflating airbag 120 ruptures a tear seam in the cover 122 that enables the cover 122 to fall away so that the airbag 120 can fully deploy.

The method and system of airbag mounting and deployment described above is provided by way of example only. Accordingly, in other embodiments, airbags configured in accordance with the present technology can be carried on restraints (e.g., two-point restraints, three-point restraints (e.g., a lap seat belt in combination with a shoulder belt), etc.) and deployed therefrom using other structures and systems in differing arrangements. Additionally, in some other embodiments airbags configured in accordance with the present disclosure can be carried (e.g., stowed) on, and deployed from, monuments, seatbacks, and/or other structures in the seating area rather than a seat belt restraint.

FIG. 1B is an isometric view of the seating area 104 immediately after the airbag 120 has deployed from the seat belt 118 in response to, for example, a rapid deceleration event (e.g., a collision) or other significant dynamic event. The airbag 120 described herein can be referred to as a barrier airbag that is intended to act as a cushioning barrier between the seat occupant 100 and a strike hazard (e.g., a surface, object, etc.; not shown) and/or the occupant his/herself (e.g., the occupant's knees, thighs, etc.). In the illustrated embodiment, the airbag 120 includes a first airbag portion 130 and a second airbag portion 132. As described in greater detail below, the first airbag portion 130 can be directly attached to the second web portion 112b and inflate generally upward in front of the occupant's torso. The second airbag portion 132 is attached to the first airbag portion 130 and inflates in front of the first airbag portion 130 with an upper portion of the second airbag portion 132 extending above the first airbag portion 130 in front of the occupant's head. As also described in more detail below, each of the airbag portions 130, 132 can include multiple (e.g., two or more) chambers which enable the airbag 120 to maintain a shape when fully inflated that reduces the tendency of the airbag 120 to deflect off of strike objects upon impact and/or reduces the tendency of the occupant's head to deflect off of the airbag 120 upon impact.

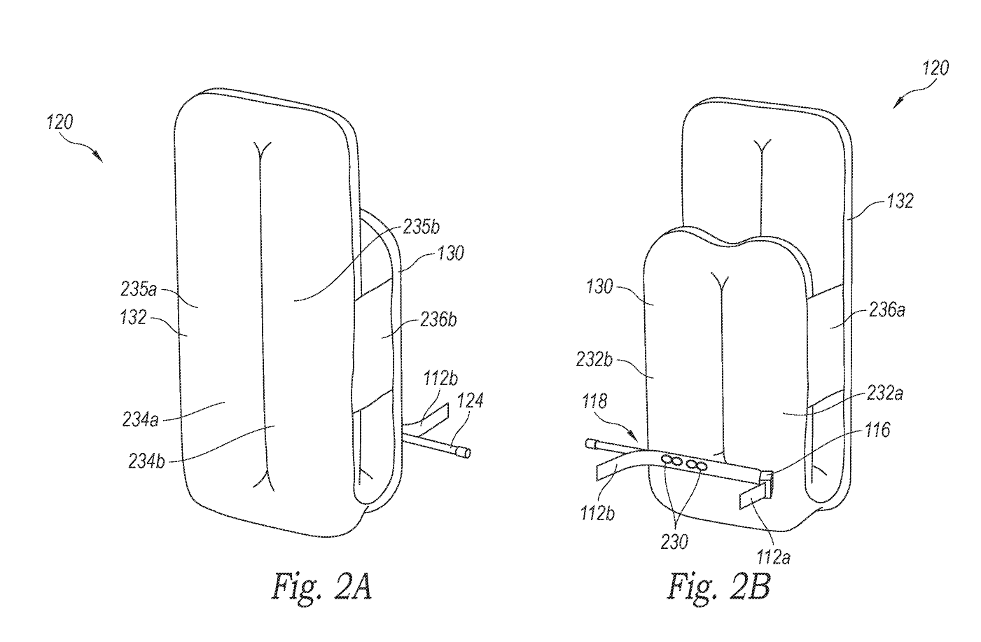

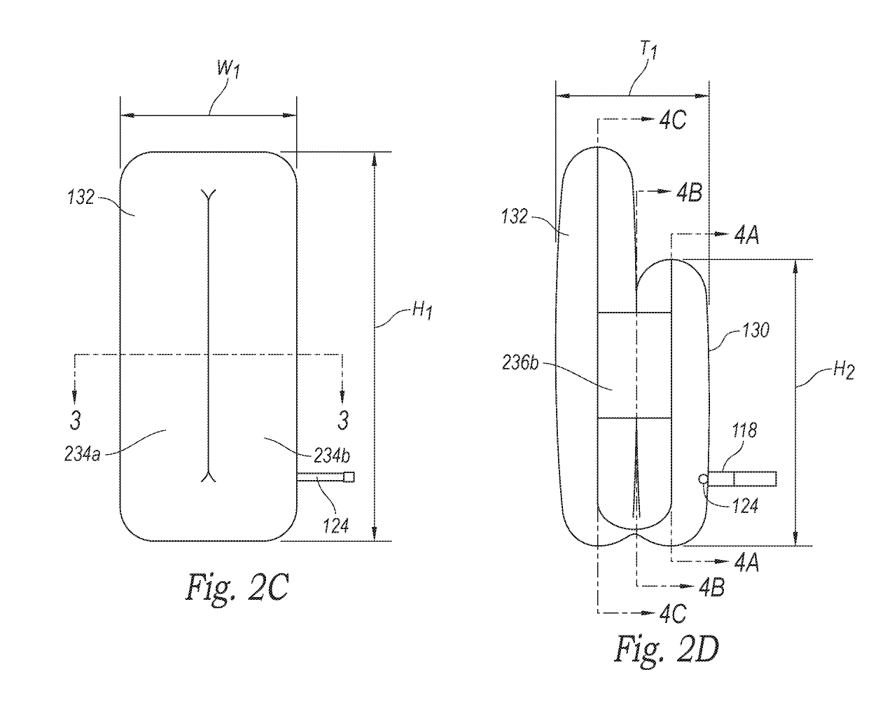

FIGS. 2A-2D are a series of front isometric, rear isometric, front and side views, respectively, of the airbag 120 configured in accordance with an embodiment of the present technology. Referring first to FIGS. 2A and 2B, in the illustrated embodiment the first airbag portion 130 includes a first chamber 232a and a second chamber 232b, and the second airbag portion 132 similarly includes a first chamber 234a and a second chamber 234b. In the illustrated embodiment, each of the chambers 232, 234 has a generally cylindrical cross-sectional shape when inflated, and each of the chambers 232, 234 is arranged in a generally vertical orientation in which each of the chambers are generally parallel to each other. In other embodiments, however, multi-chamber airbags configured in accordance with the present disclosure can include more or fewer chambers and/or in other orientations. For example, in some other embodiments the first airbag portion 130 and/or the second airbag portion 132 can include three or more individual chambers. In further embodiments, the first airbag portion 130 and/or the second airbag portion 132 can include a single chamber. In yet other embodiments, the second airbag portion 132 can be omitted and the airbag 120 can include the first airbag portion 130 with multiple (e.g., two or more) individual chambers.

The first airbag portion 130 is at least partially attached to the second airbag portion 132 by a first tether 236a on one side of the airbag 120, and a second tether 236b on the other side of the airbag 120. The tethers 236a, b can be made of airbag material (e.g., silicone coated nylon, polyester, etc.) that is attached (e.g., by stitching with a suitable strength thread, adhesive, etc.) to each of the airbag portions 130, 132. As illustrated in FIG. 2B, the first airbag portion 130 is attached to the second web portion 112b of the restraint 118 by stitching 230. The stitching 230 can include one or more patterns of thread that is stitched between the mated portions of material to fixedly attached the first airbag portion 130 to the second web portion 112b. In other embodiments, the first airbag portion 130 can be attached to the second web portion 112b with other suitable attachment means, including, for example, fasteners (e.g., rivets), adhesives, etc.

Referring next to FIGS. 2C and 2D, in the illustrated embodiment the airbag 120 has a generally rectangular frontal shape when inflated with an overall height H1 and an overall width W. In some embodiments, the overall height H1 can range from about 1.5 feet to about 4 feet, or from about 2 feet to about 4 feet, or can be about 3 feet. The overall width W1 can range from about 8 inches to about 3 feet, or from about 1 foot to about 2.5 feet, or can be about 2 feet. In some embodiments, the first airbag portion 130 can have a height H2 that is less than the height H1 of the second airbag portion 132. For example, the height H2 can range from about 1 foot to about 3 feet, or from about 1.5 feet to about 2.5 feet, or can be about 2 feet. The airbag 120 can have an overall thickness T1 that can range from about 8 inches to about 3 feet, or from about 1 foot to about 2.5 feet, or can be about 2 feet. The foregoing dimensions are provided by way of examples of some embodiments. Accordingly, in other embodiments airbags configured in accordance with the present technology can have other dimensions.

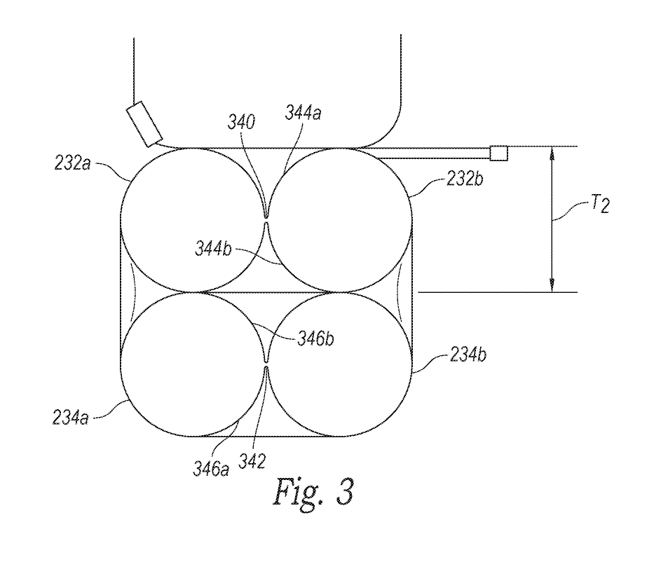

FIG. 3 is a cross-sectional top view taken substantially along line 3-3 in FIG. 2C. In the illustrated embodiment, each of the airbag chambers 232a, b and 234a, b can have the same, or at least approximately the same cross-sectional shape and size. More specifically, in this embodiment each of the airbag chambers 232a, b and 234a, b can have a generally circular cross-sectional shape of diameter T2, in which T2 can be equal to about one half of T1 (FIG. 2D). In other embodiments, however, the airbag chambers 232a, b and 234a, b can have other cross-sectional shapes without departing from the present disclosure. Additionally, in other embodiments the cross-sectional shapes and/or sizes of the airbag chambers 232a, b of the first airbag portion 130 can be different than the cross-sectional shapes and/or sizes of the airbag chambers 234a, b of the second airbag portion 132.

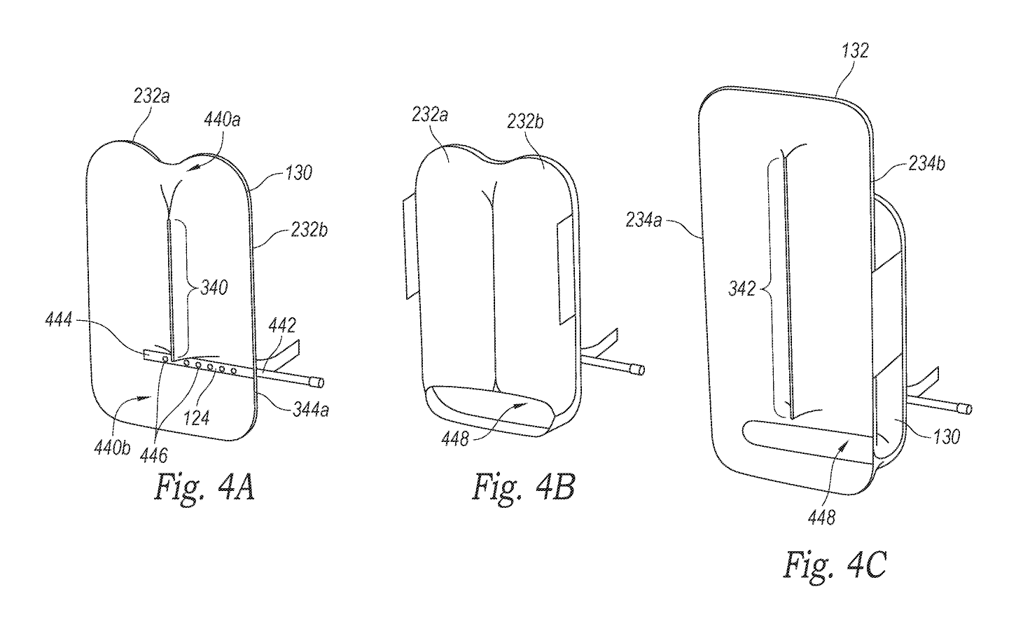

The airbag chambers 232a, b and 234a, bcan be formed from suitable airbag materials in a number of different ways. In the illustrated embodiment, for example, the first airbag chamber 232a and the second airbag chamber 232b of the first airbag portion 130 can be at least partially formed by stitching a rear-facing panel 344a to a forward-facing panel 344b along a vertical seam 340. Similarly, the first airbag chamber 234a and the second airbag chamber 234b of the second airbag portion 132 can be formed by stitching a rear-facing panel 346b to a forward-facing panel 346a along a vertical seam 342. Further aspects of airbag construction are described in greater detail below with reference to, for example, FIGS. 4A-4C.

FIGS. 4A-4C are a series of cross-sectional, front isometric views of the airbag 120 taken substantially along lines 4A-4A, 4B-4B, and 4C-4C, respectively, in FIG. 2D. Referring first to FIG. 4A, the gas hose 124 extends through an opening 442 in the rear-facing panel 344a and into the interior of the first airbag portion 130. An end portion of the gas hose 124 is fixedly attached to the rear-facing panel 344a by stitching 444 or other suitable means (e.g., adhesive, fasteners, etc.). The gas hose 124 includes one or more apertures 446 that enable high pressure gas from the inflator (not shown) to rapidly flow into the airbag 120 for inflation of the airbag 120.

As further illustrated in FIG. 4A, the stitching 340 forms a vertical seam at least partially separating the first airbag portion 130 into the first airbag chamber 232a and the second airbag chamber 232b. In the illustrated embodiment, the stitching 340 does not extend all the way to the top or bottom of the first airbag portion 130, thereby creating open passages 440a and 440b at the top and bottom, respectively, that enable gas to flow between the two chambers 232a, b during airbag inflation and operation. The stitching 340, however, provides the first airbag portion 130 with its multi-chamber form which, as described above, can provide certain advantages in operation.

Referring to FIG. 4B, the airbag 120 includes an open passage 448 extending between the lower portions of the first airbag portion 130 and the second airbag portion 132. Although the passage 448 of the illustrated embodiment is defined by a single opening, in other embodiments the airbag 120 can include a plurality of open passages to allow suitable fluid communication between the first airbag portion 130 and the second airbag portion 132. For example, in other embodiments, the airbag 120 can include one or more openings (e.g., circular openings) between the forward-facing panel 344b of the first airbag portion 130 (FIG. 3) and the rear-facing panel 346b of the second airbag portion 132.

Referring next to FIG. 4C, as this view illustrates the stitching 342 forms a vertical seam that at least partially divides the second airbag portion 132 into the first airbag chamber 234a and the second airbag chamber 234b. Although the structures 234a, b are referred to herein as separate “chambers,” it should be noted that the stitching 342 (like the stitching 340) does not extend the full height of the second airbag portion 132 and, as a result, the two airbag chambers 234a and 234b are connected by open passages at the top and bottom of the second airbag portion 132. Thus, as used herein, the term “chamber” does not require that the referenced airbag portion be entirely enclosed or sealed relative to other portions of the airbag. Indeed, in the illustrated embodiment the airbag chambers 232a, b and 234a, b are in fluid communication such that gas can flow from one to another as would be necessary, for example, for proper inflation in use and/or venting (deflation) after use. In other embodiments, however, one or more of the airbag chambers 232a, b and/or 234a, b may be entirely or otherwise substantially sealed with respect to other of the airbag chambers 232a, b and/or 234a, b. As described in greater detail below, in some embodiments the airbag 120 can include one or more vents (not shown) that open (e.g., actively or passively) to allow gas to rapidly escape from the airbag after inflation. As is known, the use of a vent can allow the airbag 120 to maintain sufficient pressure during an accident or other rapid deceleration event to protect the occupant on impact, but then allow the airbag to rapidly deflate after impact to, for example, reduce occupant rebound.

The airbag 120 can be manufactured using suitable airbag materials and construction techniques known to those of ordinary skill in the art. For example, in some embodiments the airbag 120 can be constructive by sewing together a plurality of flat panels or sheets of suitable material, such as silicone coated nylon fabric (e.g., 315 denier silicone coated woven nylon fabric), with a suitable-strength thread using known techniques. In other embodiments, airbags configured in accordance with the present disclosure can be constructed using other materials and other suitable construction techniques.

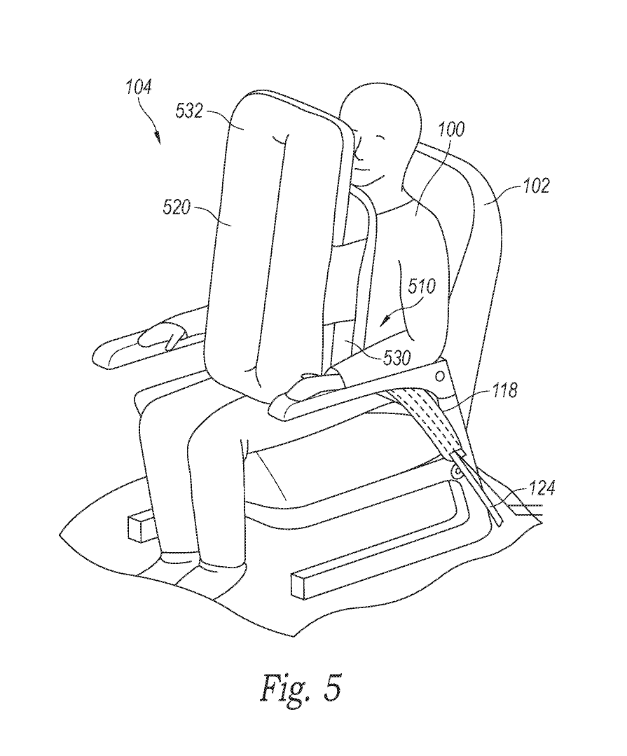

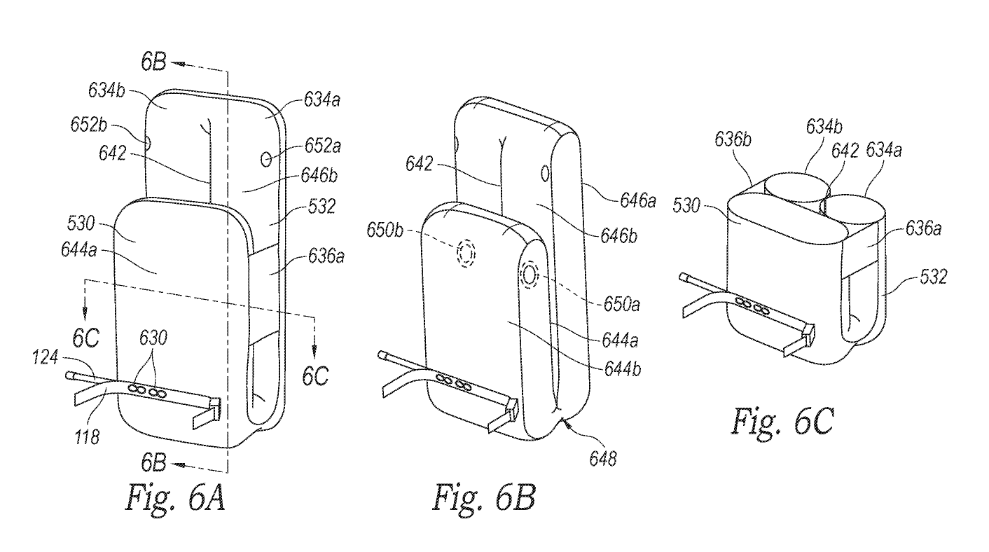

FIG. 5 is a front isometric view of the seat occupant 100 secured in the seat 102 by a restraint system 510 having a multi-chamber airbag 520 configured in accordance with another embodiment of the present technology. In the illustrated embodiment, the seat 102 is positioned in the aircraft seating area 104 described above with reference to FIG. 1A, and the airbag 520 has deployed from the seat belt 118 in response to, for example, a rapid deceleration event (e.g., an impact, collision, etc.). The restraint system 510 and the airbag 520 are at least generally similar in structure and function to the corresponding restraint system 110 and airbag 120, respectively, described in detail above with reference to FIGS. 1A-4C. For example, the airbag 520 is attached to a web portion of the seat belt 118, and includes a first airbag portion 530 and a second airbag portion 532. In the illustrated embodiment, however, the airbag 520 differs from the airbag 120 in that the first airbag portion 530 only includes a single chamber while the second airbag portion 532 includes two chambers, as described in greater detail below with reference to FIGS. 6A-6C.

FIG. 6A is a rear isometric view of the inflated airbag 520, FIG. 6B is a side cross-sectional, rear isometric view of the airbag 520 taken substantially along line 6B-6B in FIG. 6A, and FIG. 6C is a top cross-sectional, rear isometric view of the airbag 520 taken substantially along line 6C-6C in FIG. 6A. Referring to FIGS. 6A-6C together, the second airbag portion 532 of the airbag 520 can be at least generally similar in structure and function to the second airbag portion 132 of the airbag 120 described above. For example, in the illustrated embodiment the second airbag portion 532 includes a forward facing panel 646a and a rear facing panel 646b that can be stitched together by stitching 642 to create a vertical seam that separates the second airbag portion 532 into a first chamber 634a and a second chamber 634b. As shown in FIG. 6C, the first and second chambers 634a, b can be at least generally circular in cross-sectional shape when inflated.

In contrast to the second airbag portion 532, the first airbag portion 530 of the illustrated embodiment includes a single chamber 632 having a forward facing panel 644a a rear facing panel 644b. The first airbag portion 530 can be secured to the second airbag portion 532 by a first tether 636a on one side of the airbag 520, and a second tether 636b on the opposite side of the airbag 520. The forward and aft edge portions of the tethers 636 can be stitched or otherwise securely attached to the respective airbag portions to hold them together when inflated as shown in FIGS. 6A-6C.

As shown in FIG. 6B, the first and second chambers 634a, b of the second airbag portion 532 are in fluid communication with the chamber 632 of the first airbag portion 530 via an open passage 648 that extends between the two airbag portions at a bottom portion thereof. Additionally, in some embodiments one or more openings 650a and 650b can be provided between the forward facing panel 644a of the first airbag portion 530 and the rear facing panel 646b of the second airbag portion 532 so that the two airbag portions can vent internally between each other. For example, in some embodiments the openings 650 can be created by stitching the opposing panels 644a, 646b together around the perimeter of the openings 650a, b.

The airbag 520 can be secured to a web of the seat belt 118 with stitching 630 in the manner described above for the airbag 120. Similarly, a gas hose 124 can be operably connected in fluid communication to the airbag 520 for rapid inflation and deployment as described in detail above. In some embodiments, the airbag 520 can include one or more vents to allow the airbag 520 to rapidly deflate after deployment. For example, in some embodiments the airbag 520 can include one or more vent openings 652a, b that are sized and/or positioned to vent the airbag 520 at a desired rate and prevent potential occupant injuries from rebounding off of the airbag 520 in use. For example, in the illustrated embodiment the vent openings 652a, b can be circular openings having diameters of, for example, about 0.25 inch to about 3 inches, about 0.5 inch to about 2 inches, about 0.75 inch to about 1.25 inches, or about 1 inch. In some embodiments, the vent openings 652a, b can simply be uncovered openings, and in other embodiments the vent openings 652a, b can be at least partially closed by stitching or other means that is configured to rupture at a predetermined internal pressure. Additionally, the vent openings 652a, b can be sized and/or positioned to cause the airbag 520 to deflate in a desired manner that can minimize or at least reduce the likelihood of occupant injury. For example, in some embodiments the vent openings 652a, b can be located in an upper portion of the rear facing panel 646b of the second airbag portion 532. In these embodiments, it is contemplated that this location of the vent openings 652a, b can favorably influence the occupant's body position and rebound upon impact with the airbag 520 because the gas within the airbag 520 must travel from the first airbag portion 530 to the second airbag portion 532 before being released. Without wishing to be bound by theory, it is thought that deflation of the airbag 520 in this manner causes the first airbag portion 530 to maintain internal pressure longer than the second airbag portion 532. Since the second airbag portion 532 contacts the forward strike object (e.g., a monument, forward seat back, etc.) first, however, deflation of the second airbag portion 532 reduces the rebound of the airbag 520 from the initial contact with the strike object, while the first airbag portion 530 momentarily maintains pressure to continue cushioning the occupant before it deflates to further reduce rebound. In other embodiments, the relative sizes of the vent openings 652a, b can be varied from side to side to influence the direction of rebound of the occupant's body.

As will be appreciated by those of ordinary skill in the art, the passive vent openings 652a, b described above are but one example of vents that can be used for the multi-chamber airbags described herein. In other embodiments, other types of vents, including both active and passive vents, can be used with the multi-chamber airbags described herein without departing from the present disclosure. In yet other embodiments, vents can be omitted in one or more of the airbag portions. Accordingly, the multi-chamber airbags described in detail herein are not limited to use or inclusion of any particular vent system.

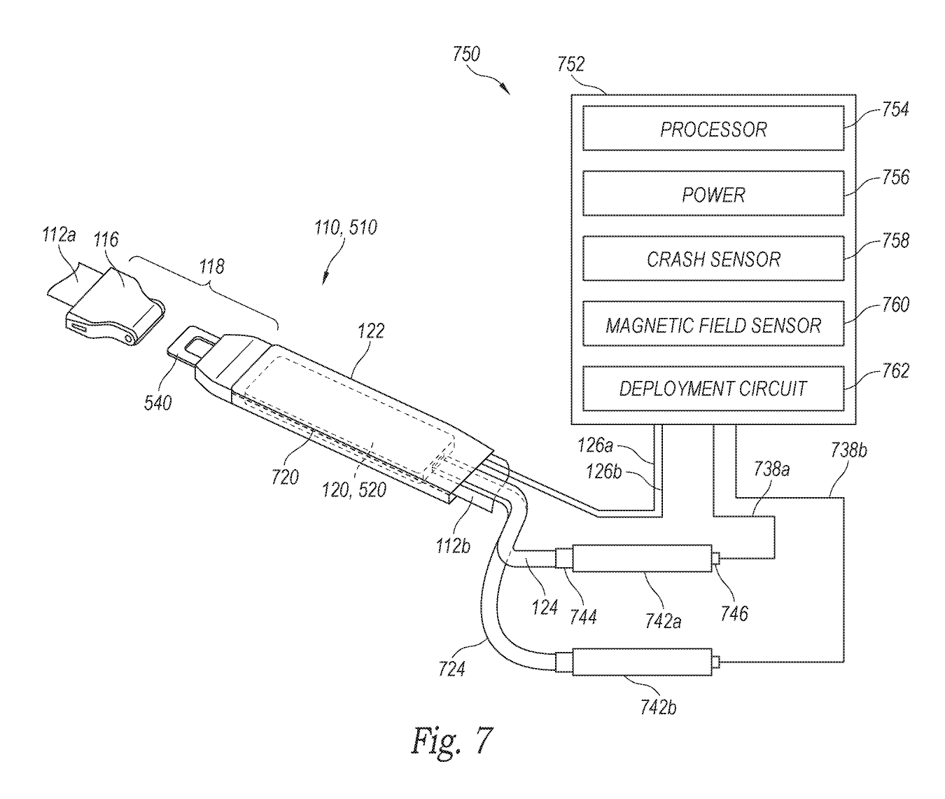

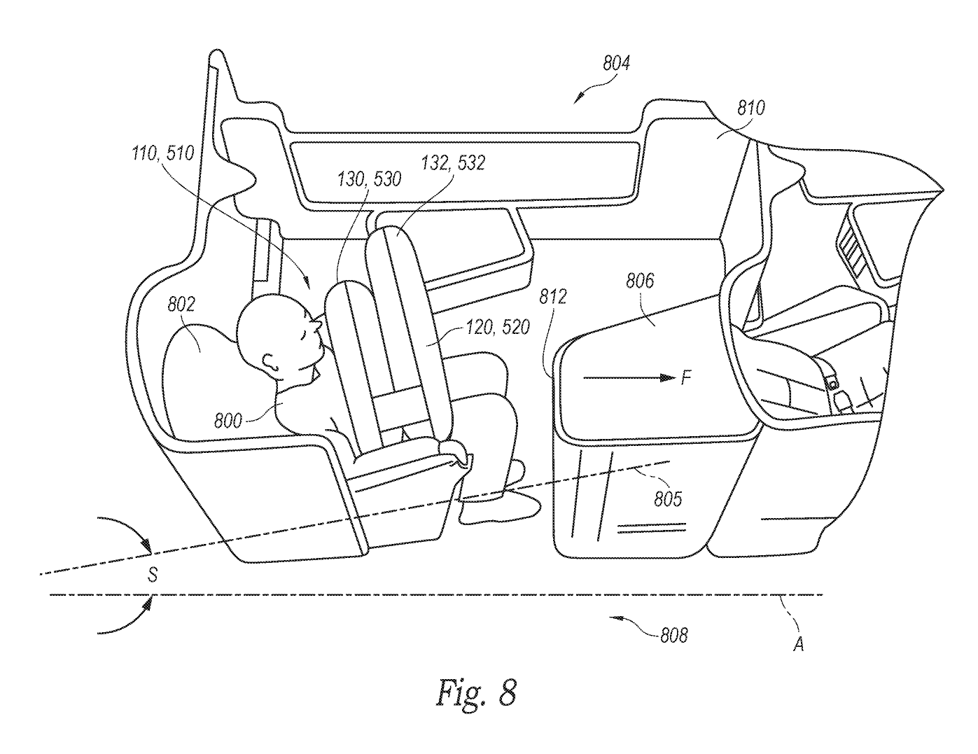

FIG. 7 is a partially schematic isometric view of an airbag deployment system 750 operably connected to a multi-chamber airbag stowed on the seat belt 118 in accordance with an embodiment of the present technology. In the illustrated embodiment, the multi-chamber airbag can be the airbag 120 or the airbag 520 described in detail above, or other airbags configured in accordance with the present disclosure. In some embodiments, the airbag deployment system 750 includes an electronic assembly 752 (e.g., an electronic module assembly (EMA); shown schematically) and a first inflator 742a. The electronic assembly 752 and/or the first inflator 742a can be located, for example, under the seat 102 (FIGS. 1A, 5), under an adjacent seat, or in other locations suitable for connectivity to the airbag 120, 520. Various types of inflators known in the art can be used with the airbag systems described herein. In some embodiments, for example, the inflator 742a can include a stored gas canister that contains compressed gas (e.g., compressed air, nitrogen, argon, helium, etc.) at high pressure. The inflator 742a can include an initiator 746 (e.g., a pyrotechnic device, such as a squib) operably positioned on one end, and a coupling 744 that connects the gas hose 124 to the inflator 742a on the opposite end. In other embodiments, other suitable inflator devices well known in the art can be used without departing from the present disclosure. Such devices can include, for example, gas generator devices that generate high pressure gas through a rapid chemical reaction of an energetic propellant, hybrid inflators, etc. Accordingly, the present disclosure is not limited to a particular type of airbag inflation device and/or system.

In the illustrated embodiment, the electronic assembly 752 includes a processor 754 that receives electrical power from a power source 756 (e.g., one or more batteries, such as lithium batteries), a deployment circuit 762 that initiates the inflator 742a, and at least one crash sensor 758 (e.g., an accelerometer) that detects rapid decelerations and/or other dynamic events greater than a preset or predetermined magnitude (e.g., a deceleration greater than 15 g's). The processor 754 can include, for example, suitable processing devices for executing non-transitory instructions stored on computer-readable media. The crash sensor 758 can, for example, include a spring-mass damper type sensor with an inertial switch calibrated for the vehicle's operating environments that initiates airbag deployment upon a predetermined level of deceleration. In other embodiments, the crash sensor 758 can include other types of sensors known in the art and/or other additional features to facilitate airbag deployment. In further embodiments, some of the components of the electronic assembly 752 described above may be omitted or other components may be included.

The electronic assembly 752 can be electrically coupled to the inflator initiator 746 via one or more electrical links 738a (e.g., a wire). As discussed above, in some embodiments the restraint systems 110, 510 can include a seat belt switch (not shown) carried on a web connector 740 which is configured to change status (e.g., close a circuit or open a circuit) when the web connector 740 is suitably engaged with the buckle 116. The connector status as determined by the switch can be transmitted to the electronic assembly 752 via electrical links 126a, b to ensure that the airbag 120, 520 is only deployed when the two web portions 112a, b of the seat belt 118 are properly joined together, as this can prevent the airbag 120, 520 from inadvertently inflating when the seat belt 118 is not secured around the waist of a seat occupant.

In a dynamic event above a predetermined threshold (e.g., a rapid deceleration equal to or greater than a predetermined magnitude resulting from the aircraft experiencing a collision or other significant dynamic event), the crash sensor 758 can detect the event and respond by sending a signal to the processor 754 which causes the processor 754 to send a corresponding signal to the deployment circuit 762. Upon receiving the signal and confirmation that the connector 740 is engaged with the buckle 116, the deployment circuit 762 applies a voltage to the inflator initiator 746 via the electrical link 738a sufficient to activate the initiator 746, which opens or otherwise causes the inflator 742 to rapidly discharge its compressed gas into the airbag 120, 520 via the gas hose 124 in a known manner. The rapid expansion of the compressed gas flowing into the airbag 120 causes the airbag 120 to rapidly expand and rupture or otherwise separate a tear seam 720 on the airbag cover 122. This enables the cover 122 to move away so that the airbag 120, 520 can inflate and rapidly deploy (e.g., in about 40-55 milliseconds (ms)) as described in detail above. The tear seam 520 can include stitching with suitable thread that is configured to break upon airbag inflation. In other embodiments, the tear seam can employ adhesive or other means to hold the cover 122 together prior to airbag inflation.

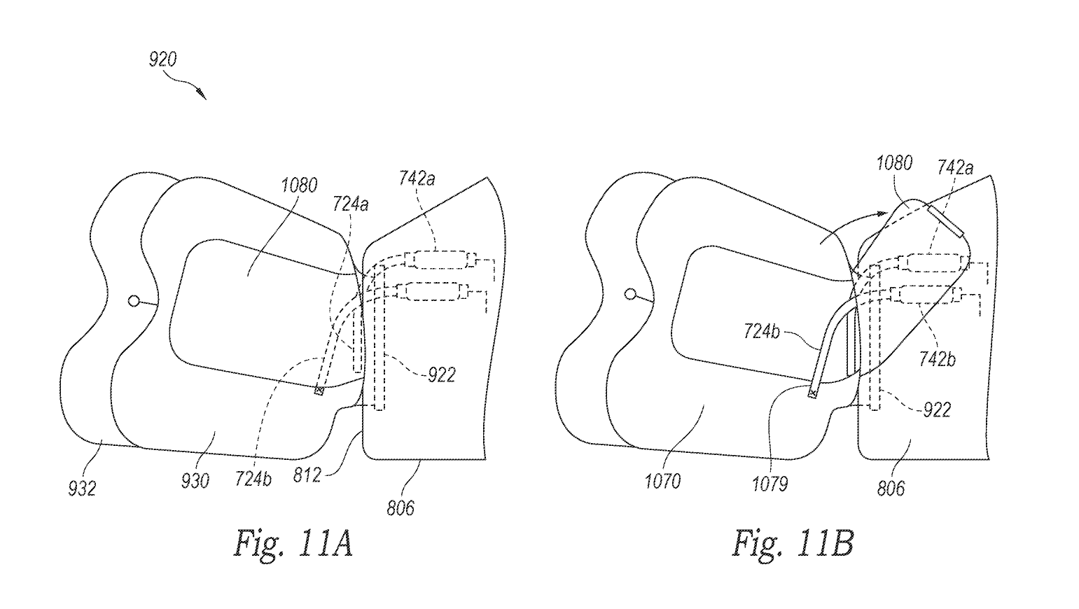

As described in greater detail below, in some embodiments the airbag deployment system 750 can further include a second inflator 742b for opening one or more active vents (not shown) on the airbag 120, 520 shortly after the first inflator 742a has inflated the airbag 120, 520. For example, the second inflator 742b can be connected to the active vent via a gas hose 724 that extends under the cover 122, and to the deployment circuit 762 via one or more second links 738b. In some embodiments, the deployment circuit 762 can include one or more timers (e.g., a resistor-capacitor circuit “RC circuit” or other timing circuit) and/or a programmable routine for transmitting a second signal to the initiator on the second inflator 742b a short period of time after the first signal is sent to the first inflator 742a or after the rapid deceleration event is detected. For example, in some embodiments the deployment circuit 762 can be configured to send the second signal to the second inflator 742b within 25 ms to 300 ms, within 50 ms to 200 ms, or within 100 ms to 180 ms after the first inflation signal is sent to the first inflator 742a. In other embodiments, the deployment circuit 762 can be configured to send the second signal to the second inflator 742b in response to other events and/or at other times after the first signal. As described in greater detail below with reference to, for example, FIGS. 11A and 11B, in response to the second signal, the second inflator 742b rapidly inflates the gas hose 724, which can open the active vent by, for example, rupturing a stitch line to release a panel or patch over a vent opening in the airbag 120, 520.

The airbag deployment, inflation and/or vent systems described above are provided by way of example of suitable systems. It should be noted, however, that the various embodiments of multi-chamber airbags described herein are not limited to use with the particular inflation and/or deflation systems described above, but can also be used with other types of inflation and/or deflation systems without departing from the present disclosure.

FIG. 8 is a top isometric view of an occupant 800 secured in a seat 802 in an aircraft seating area 804 by the restraint system 110, 510 in accordance with an embodiment of the present technology. In the illustrated embodiment, the seating area 804 can be located in, for example, a first or business class cabin of a commercial passenger aircraft, and can include a sidewall 810 (e.g., a partition between the seating area 804 and an adjacent seating area, an outer wall of the aircraft fuselage, etc.) on one side thereof, and a passenger aisle 808 (e.g., a center aisle) that provides access to the seat 802 on the other side thereof. Additionally, in the illustrated embodiment the seat 802 is an “oblique angle seat” such that a centerline 805 of the seat 802 is positioned at an angle S relative to a longitudinal axis A (or centerline) of the aircraft. For example, in some embodiments the seat 802 can be positioned at an angle S of from about 5 degrees to about 45 degrees, or from about 8 degrees to about 30 degrees, or the angle S can be 10 degrees or approximately 10 degrees relative to the longitudinal axis A. As discussed in detail above, however, in other embodiments the seat 802 can be positioned at other angles and in other orientations relative to the longitudinal axis A. The seating area 804 also includes a monument 806 (e.g., a storage area, closet, cabinet, privacy wall, partition, table, shelves, etc.) that is positioned generally forward of the seat 802 and offset to one side of the seat 802 (e.g., the aisle side) so that an aft-facing surface 812 of the monument 806 is not positioned directly in front of the occupant 800 but is instead positioned slightly to one side.

FIG. 8 depicts the airbag 120, 520 immediately after it has been inflated and deployed from the seat belt 118 (see, e.g., FIGS. 1A, 1B and 5) in response to an aircraft accident or other significant dynamic event. At the depicted point in time, the occupant's body has just begun to move forward in the direction F (i.e., parallel to the longitudinal axis A) in response to the rapid deceleration associated with the dynamic event. Referring to FIGS. 8, 2B and 6A together, the multi-chamber configuration of the airbag 120, 520 and, more specifically, the configuration of the first airbag portion 130, 530 provides a favorable surface that contacts the occupant's torso and thereby helps to align the airbag 120, 520 with the occupant 800 as the occupant 800 rotates forward about the seat belt 118. The contact area defined by the first airbag portion 130, 530 enables the airbag 120, 520 to squarely receive the occupant 800 and maintain its position between the occupant 800 and potential strike hazards.

Referring next to FIGS. 8, 1B and 5 together, a further feature of the airbag 120, 520 is that the top portion of the first airbag portion 130, 530 is configured to be positioned just under the occupant's chin. This allows the occupant's head to contact the second airbag portion 132, 532 after the occupant's torso has contacted the first airbag portion 130, 530. Allowing the occupant's upper torso to contact the first airbag portion 130, 530 before the occupant's head contacts the second airbag portion 132, 532 allows the occupant's upper torso to start slowing down before the head makes contact with the second airbag portion 132, 532. In some embodiments, this can reduce the stress placed on the occupant's neck by movement of the upper torso after the head has been restrained by the second airbag portion 132, 532.

As the occupant's upper torso continues to rotate forward about the seat belt 118, the airbag 120, 520 can provide a cushion barrier between the occupant 800 and, for example, the strike hazard presented by the aft-facing monument surface 812. As discussed above, conventional single-chamber barrier airbags typically assume a generally cylindrical shape when fully inflated, which can cause them to deflect off of strike objects when making contact with them. Referring to FIGS. 8, 2A and 6C together, a further feature of some embodiments of the present technology is that the side-by-side arrangement of the first airbag chamber 234a, 634a and the second airbag chamber 234b, 634b of the second airbag portion 132, 532 provides at least two spaced-apart points of contact or surfaces (e.g., 235a and 235b in FIG. 2A) that can provide more surface area (e.g., more flat or generally flat surface area) than conventional airbags. As a result, when the airbag 120, 520 contacts the strike surface 812, the airbag 120, 520 has less of a tendency to deflect and/or rebound away from the strike surface 812, which can reduce the tendency of the occupant 800 to deflect and/or rebound away from the airbag 120, 520, thereby providing a better cushioning barrier and reducing the likelihood of injury to the occupant 800 from impacting the strike surface 812.

In the illustrated embodiment, the airbag 520 can use a single chamber “torso” airbag portion (e.g., the first airbag portion 530) that is designed to interact with the occupant's torso, and a taller, “upside down U-shaped” airbag portion (e.g., the second airbag portion 532) that is positioned between the torso airbag portion and the strike object. As noted above, the second airbag portion 532 can be designed to interact with the occupant's head. Venting second airbag portion 532 (via, e.g., the vent openings 652a, b described above with reference to FIG. 6A) can allow the occupant 800 to decelerate as it moves toward the strike object, while still maintaining the barrier provided by the first airbag portion 530. In some embodiments, the top of the first airbag portion 530 is configured to be positioned at or near the bottom of the occupant's neck, so that the occupant's head will only interact with the second airbag portion 532 behind the first airbag portion 530. As noted above, this height difference between the first airbag portion 530 and the second airbag portion 532 can enable the occupant's torso to contact the first airbag portion 530 and begin slowing down before the occupant's head makes contact with the second airbag portion 532. In some embodiments, this can help reduce stress on the occupant's head and/or neck from twisting by reducing the amount of energy that the torso can apply through the neck as the head contacts the second airbag portion 532.

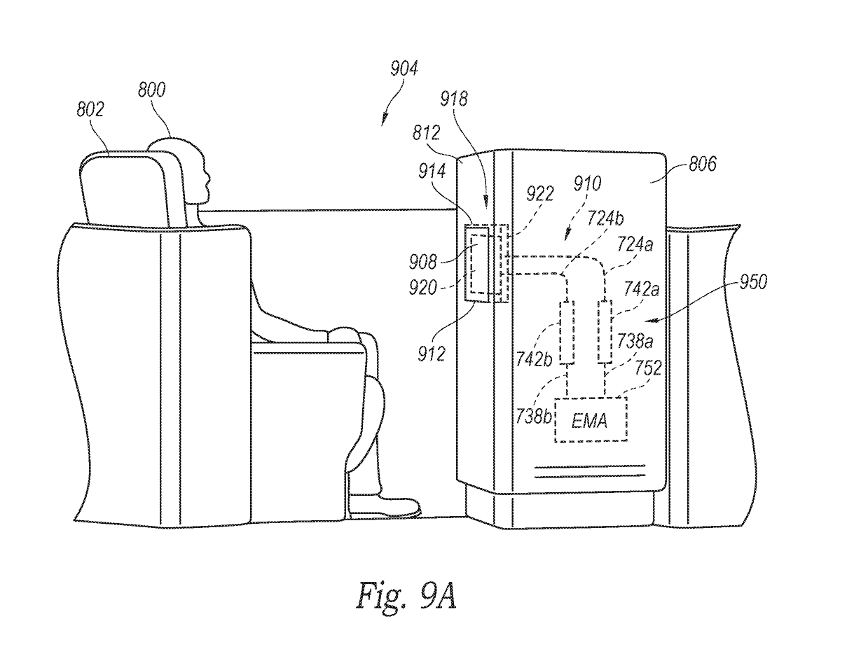

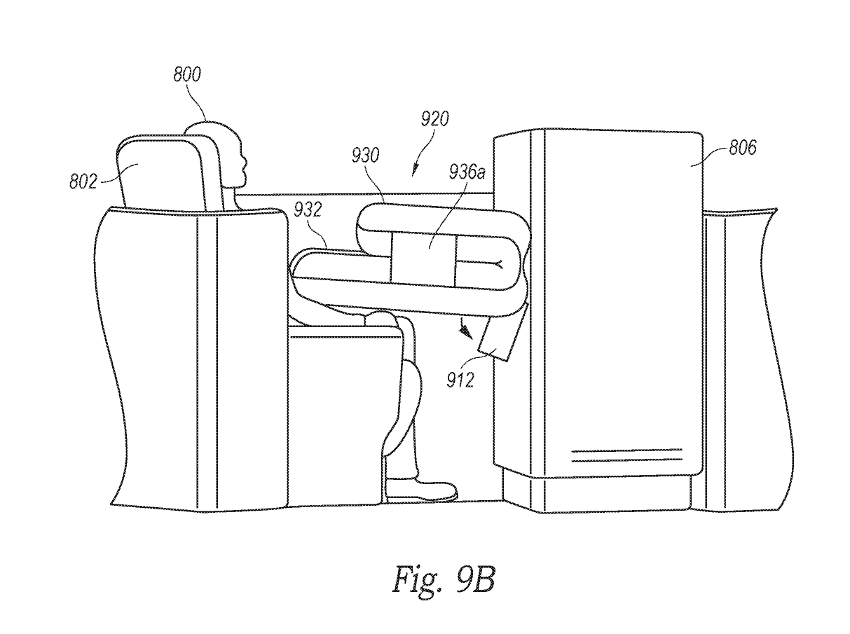

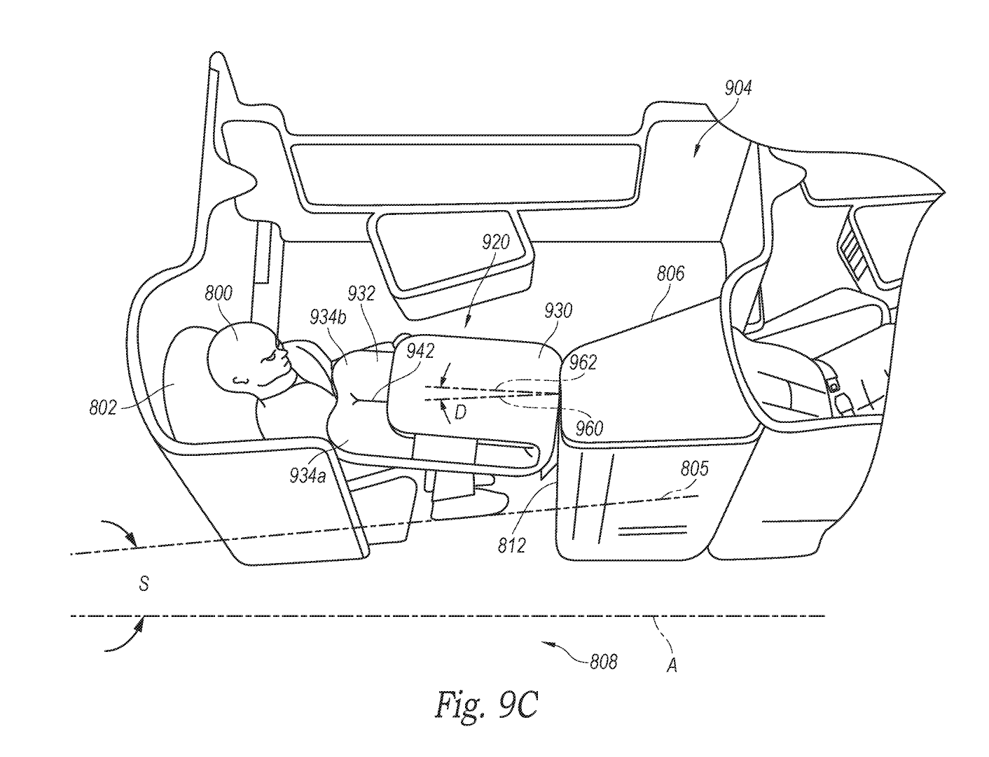

FIG. 9A is a side isometric view of an aircraft seating area 904 having a structure-mounted airbag system 910 with a multi-chamber airbag 920 configured in accordance with an embodiment of the present technology. FIGS. 9B and 9C are side and top isometric views, respectively, of the seating area 904 after the multi-chamber airbag 920 has deployed from the monument 806. Referring first to FIG. 9C, as this view illustrates the aircraft seating area 904 can be at least generally similar to the aircraft seating area 804 described in detail above with reference to FIG. 8. For example, the seating area 904 is an oblique seating arrangement in which the passenger seat 802 is positioned at the angle S relative to the longitudinal axis A of the aircraft. Additionally, the seating area 904 includes the monument 806 that, in the illustrated embodiment, is positioned generally forward of the seat 802 and offset to one side of the seat 802 to provide room for, e.g., the passenger's feet and/or legs to extend in front of the seat 802. As a result, in the illustrated embodiment the aft-facing surface 812 of the monument 806 is not positioned directly in front of the seat occupant 800, but the aft-facing surface 812 would be in the occupant's path of travel in the event the aircraft experienced a sudden stop or other rapid deceleration that caused the occupant 800 to pitch forward in direction F parallel to the longitudinal axis A.

Referring next to FIG. 9A, in the illustrated embodiment the airbag system 910 includes an airbag assembly 918 and an airbag inflation system 950. The airbag assembly 918 includes the multi-chamber airbag 920 that can be attached to a mounting plate 922 and stowed within, e.g., a suitable housing in the monument 806 behind a flap or door 908. The mounting plate 922 can be a rigid plate attached to an interior wall or other structure in the monument 806 behind the door 908. The airbag 920 can be attached to the mounting plate 922 via straps that have one end fastened to the plate and the other end sewn to the fabric airbag material, or the airbag can be attached to the mounting plate 922 with mechanical fasteners that extend through the airbag material, or by other suitable methods known in the art. The airbag 920 can be folded into a compact form and stowed behind the door 908, and secured in place with a tether having a breakaway stitch that releases the airbag upon inflation for deployment. The airbag door 908 can be disposed in an opening (e.g., a rectangular opening) 914 in a sidewall (e.g., the aft surface 812) of the monument 806. The door 908 can be pivotally mounted to an edge portion of the opening in the monument 806 by a suitable hinge 912 extending along, for example, a bottom edge portion of the door 908, and one or more fasteners (not shown), such as frangible nylon screws, can be used to releasably secure one or more of the remaining three edges of the door 908 to the monument 806. In other embodiments, the door 908 can be releasably secured in the closed position by other means known in the art, including other types of fasteners, adhesives, weakness lines (e.g., grooves, cuts, or a series of holes around the perimeter of the door that break-away under pressure from airbag deployment), etc. In further embodiments, rather than pivot, the door 908 can be configured to separate entirely from the monument 806 during airbag deployment, and the door 908 can be restrained by one or more tethers to the monument 806.

In the illustrated embodiment, the airbag inflation system 950 can be at least generally similar in structure and function to the airbag deployment system 750 described above with reference to FIG. 7. For example, the deployment system 950 can include the electronic assembly 752 which is electrically connected to the first inflator 742a by the first electrical link 738a, and to the second inflator 742b by the second electrical link 738b. A first gas hose 724a is operably coupled between an outlet on the first inflator 742a and the airbag 920 for inflation thereof. Similarly, a second gas hose 724b is operably coupled between an outlet on the second inflator 742b and an active vent (not shown in FIG. 9A) on the airbag 920.

Referring next to FIGS. 9A and 9B together, when the aircraft experiences a rapid deceleration (e.g., greater than or equal to 15 g's) the crash sensor detects the event and causes the deployment circuit to apply a voltage to the initiator of the first inflator 742a as described above with reference to FIG. 7. This causes the first inflator 742a to rapidly discharge its compressed gas into the airbag 920 via the first gas hose 724a, rapidly inflating the airbag 920 and deploying it outwardly from the monument 806 through the opening 914. As the airbag 920 pushes through the opening 914, it displaces the door 908 which pivots downwardly about the hinge 912.

Referring next to FIG. 9C, as this view illustrates the multi-chamber airbag 920 is at least generally similar in structure and function to the airbag 520 described in detail above with reference to FIGS. 5-6C. For example, the multi-chamber airbag 920 includes a first airbag portion 930 and a second airbag portion 932 that are at least generally similar in structure and function to the first airbag portion 530 and the second airbag portion 532, respectively, of the airbag 520. More specifically, in the illustrated embodiment the second airbag portion 932 is a multi-chamber portion that includes a first chamber 934a at least partially separated from a second chamber 934b by means of a seam created by stitching 942 or other suitable attachment means. Like the airbag 520, however, the first airbag portion 930 of the airbag 920 is a single-chamber portion. The first airbag portion 930 is attached to the second airbag portion 932 with tethers 936a, b in the manner described above for the multi-chamber airbag 520. One difference between airbag 920 and the airbag 520, however, is that the airbag 920 inflates and deploys outwardly from the monument 806 in a generally horizontal orientation toward the seat occupant 800, with the second airbag portion 932 positioned beneath, or at least generally beneath the first airbag portion 930.

As noted above, in some embodiments the aft-facing surface 812 of the monument 806 may be slightly offset to one side of the seat occupant 800 and not positioned directly in front of the seat occupant 800. (In this context, “directly in front of the seat occupant” refers to the direction that the seat 802 and the occupant 800 are facing, which in the illustrated embodiment is at an angle relative to the axis A). Accordingly, in these embodiments it may be advantageous to configure the airbag 920 so that it deploys outwardly from the monument 806 at an angle toward the seat occupant 800. For example, in the illustrated embodiment a first line 960 represents a direction perpendicular to the aft-facing surface 812, and the airbag 920 is configured to deploy in the direction of a second line 962 that is oriented toward the occupant 800 at an angle D relative to the line 960. In some embodiments, for example, the angle D can be from about 2 degrees to about 30 degrees, or from about 5 degrees to about 20 degrees, or from about 5 degrees to about 15 degrees, or about 10 degrees. In other embodiments, the airbag 920 can be configured to deploy at other angles relative to the monument 806, or the airbag 920 can be configured to deploy straight out from the aft-facing surface 812.

As shown in FIGS. 9B and 9C, the second airbag portion 932 is longer than the first airbag portion 930 and extends out past the first or upper airbag portion 930 toward the seat occupant 800. In some embodiments, this configuration can advantageously enable the occupant's upper torso/neck to contact the two chambers 934a, b of the second airbag portion 932 to help center the airbag 920 relative to the occupant 800, and then allow the occupant's head to contact the single chamber of the first airbag portion 930 to slow down and cushion the occupant's head before the airbag compresses against the strike object (e.g., the monument 806).

In some embodiments, the advantageous features of the multi-chamber airbags described herein can be used in the next generation of first class and business class seating arrangements in aircraft having, for example, oblique-angled seats with, for example, curved partition walls which can or may present new occupant interactions with the walls in the event of an emergency crash-type situation. Embodiments of the multi-chambered airbags described herein can also address issues associated with curved and other impact surfaces in oblique and other seating arrangements, and in some embodiments the airbags described herein can also reduce occupant neck twist from occupant interaction with the airbag. It should be recognized, however, that references throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment may be included in at least one embodiment of the present technology.

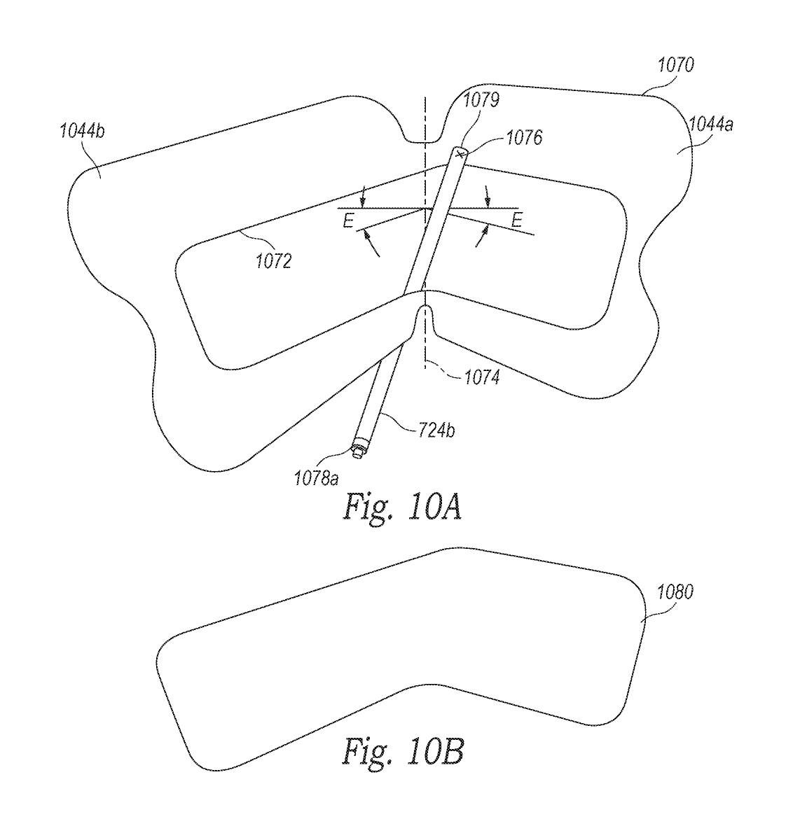

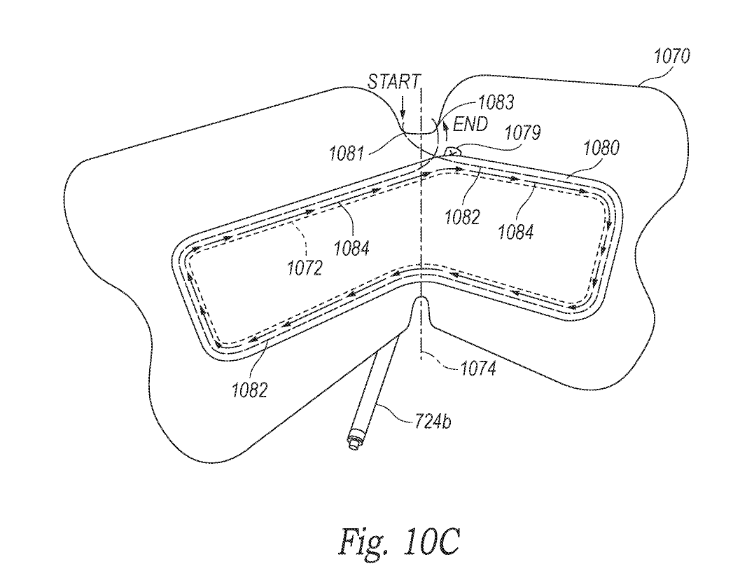

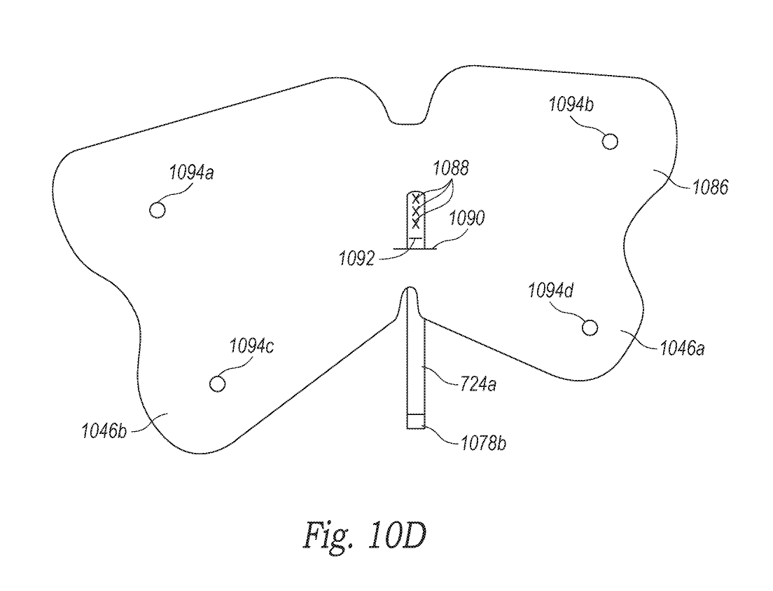

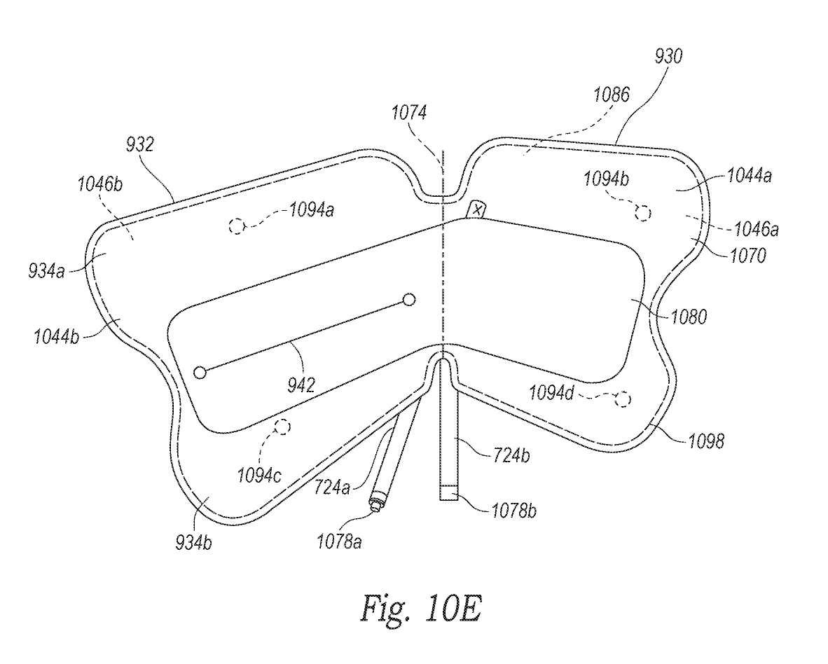

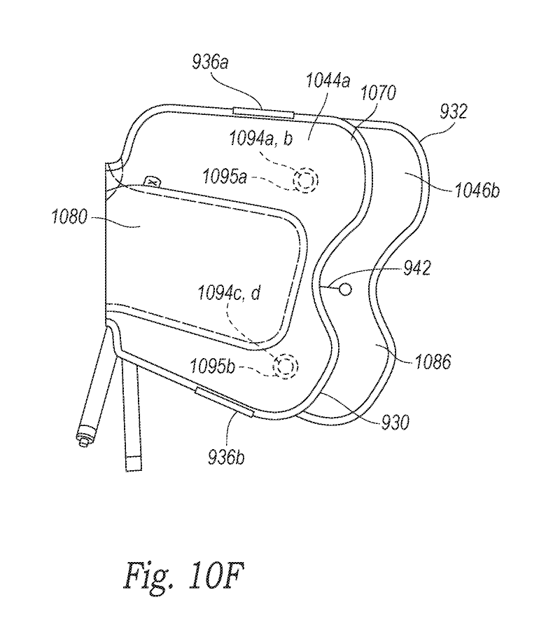

FIGS. 10A-10F are a series of plan views illustrating materials and construction techniques for manufacturing a multi-chamber airbag (e.g., the multi-chamber airbag 920 described above) in accordance with an embodiment of the present technology. Although the following description refers to the airbag 920, the materials and processes described therein can be applied to other multi-chamber airbags configured in accordance with the present disclosure including, for example, the multi-chamber airbags 520 and 120 described in detail above. FIG. 10A illustrates an outer plan view of a flat pattern of an outer airbag panel 1070 having a first panel portion 1044a extending from one side of a fold line 1074, and a second panel portion 1044b extending from the other side of the foldline 1074. The outer panel 1070 can be made from any suitable airbag material known in the art including, for example, nylon fabric, such as silicone coated nylon fabric (e.g., 315 denier silicone coated woven nylon fabric), and can define a flexible wall portion of the airbag. In the illustrated embodiment, the first and second panel portions 1044a, b extend outwardly from the foldline 1074 at an angle E. In some embodiments, the angle E can be from about 2 degrees to about 30 degrees, or from about 5 degrees to about 20 degrees, or about 10 degrees. The purpose of the angle E is so that the finished airbag 920 will inflate and deploy outwardly from its mounting location (e.g., the aft-facing surface 812 of FIG. 9C) at an angle toward the seat occupant. Such an angle may be desirable in those instances in which the airbag mounting location is not positioned directly in front of the seat occupant, but instead may be positioned to one side. In such instances, the angle E enables the airbag to inflate and deploy outwardly from the mounting location at an angle toward the seat occupant. In other embodiments, such as embodiments in which the airbag 920 deploys from a structure or location positioned generally in front of the seat occupant, the angle E can be omitted so that the first panel portion 1044a and the second panel portion 1044b extend perpendicularly, or at least approximately perpendicularly, from the fold line 1074.

As discussed above with reference to, for example, FIG. 9A, in some embodiments airbag 920 can include an active vent system for rapid deflation and reducing occupant rebound. In the illustrated embodiment, the active vent system includes the second gas hose 724b and an opening 1072 in the outer panel 1070. In this embodiment, a distal end portion 1079 of the second gas hose 724b is fixedly attached to the outer surface of the outer panel 1070 proximate an edge portion of the opening 1072 and proximate the fold line 1074. The end portion 1079 can be attached to the outer panel 1070 with stitching 1076 or other suitable fasteners. The second gas hose 724b is routed through the opening 1072 adjacent the inner surface of the outer panel 1070. A coupling 1078a is attached to the proximal end portion of the second gas hose 724b for coupling the second gas hose 724b to the second inflator 742b (FIG. 9A). Unlike a gas hose for filling the airbag 920, however, the second gas hose 724b does not include a diffuser or any openings to allow the pressurized gas from the second inflator 742b to flow into the airbag 920. Instead, the second gas hose 724b is generally sealed so that the pressurized gas from the second inflator 742b causes it to inflate and expand rapidly upon activation of the second inflator 742b.

FIG. 10B illustrates an outer plan view of a flat pattern of a vent panel 1080 that is shaped and sized to fit over the opening 1072. FIG. 10C is an outer plan view of the vent panel 1080 positioned over the opening 1072. As these views illustrate, in the illustrated embodiment the distal end portion 1079 of the second gas hose 724b is sandwiched between the outer panel 1070 and the vent panel 1080 proximate an edge portion of the opening 1072. The vent panel 1080 is then secured to the outer panel 1070 with stitching 1083 that extends around the outer edge portion or perimeter of the vent panel 1080 so that the vent panel 1080 covers, or at least substantially covers, the opening 1072. In one aspect of this embodiment, the stitching 1082 can include a single needle chain stitch using, for example, high tensile strength synthetic fiber, such as Kevlar® thread. In other embodiments, the vent panel 1080 can be attached to the outer panel 1070 using different stitch configurations and/or different types of thread. In another aspect of this embodiment, the stitching 1082 starts in a first location 1081 proximate the fold line 1074, and proceeds around the opening 1072 in a direction indicated by the arrows 1084 before ending at a second location 1083 proximate the other side of the fold line 1074. As described in greater detail below, the start point, endpoint, and direction of the stitching 1082 can facilitate the rapid displacement of the vent panel 1080 from the airbag 920 in response to inflation of the second gas hose 724b. In other embodiments, however, the multi-chamber airbags configured in accordance with the present disclosure can include other types of vent systems, including both active and passive vent systems, having other openings with other shapes and sizes, other stitch patterns, etc. without departing from the present disclosure. For example, in some embodiments airbags configured with the present disclosure can include one or more of the vent systems described in U.S. patent application Ser. No. 15/096,158, filed Apr. 11, 2016, and titled ACTIVE AIRBAG VENT SYSTEM, which is incorporated herein by reference in its entirety. In yet other embodiments, airbags configured in accordance the present disclosure can omit active and/or passive vents.

Referring next to FIG. 10D, this view illustrates an inner plan view of a flat pattern of an inner airbag panel 1086 configured in accordance with an embodiment of the present technology. Similar to the outer panel 1070 described above, the inner panel 1086 includes a first panel portion 1046a extending from a first side of the fold line 1074 and a second panel portion 1046b extending from the opposite side of the fold line 1074. In the illustrated embodiment, the inner panel 1086 has the same shape and size, or at least approximately the same shape and size, as the outer panel 1070. In the illustrated embodiment, the inner panel 1086 includes an opening (e.g., a slit) 1090 through which the first gas hose 724a (FIG. 9A) partially extends. A distal end portion 1089 of the first gas hose 724a is attached to the inner surface of the inner panel 1086 with stitching 1088 or other suitable fasteners. Additionally, the first gas hose 724a includes one or more diffuser openings (e.g., slits) 1092 configured to permit the pressurized gas from the first inflator 742a to flow rapidly into the airbag 920 for inflation. The proximal end portion of the first gas hose 724a includes a coupling 1078b for attaching the first gas hose 724a to the first inflator 742a (FIG. 9A). In addition to the foregoing features, the inner panel 1086 additionally includes a plurality of vent openings 1094a-d. As described greater detail below, the vent openings 1094a-d are positioned so that the first vent opening 1094a will be aligned with the second vent opening 1094b, and the third vent opening 1094c will be aligned with the fourth vent opening 1094d, when the inner panel 1086 is folded about the fold line 1074 to complete construction of the airbag 920.

Referring next to FIG. 10E, the outer panel 1070 is positioned on top of the inner panel 1086 and aligned therewith. The second gas hose 724b is routed through the slit 1090 in the inner panel 1086 (FIG. 10D) so that both proximal end portions of first gas hose 724a and the second gas hose 724b extend out of the airbag 920 through the slit 1090. The outer panel 1070 is then attached to the inner panel 1086 by stitching 1098 that extends around the perimeters of the outer and inner panels 1070 and 1086. In some embodiments, the stitching 1098 can include a single row chain stitch. In other embodiments, other types of stitching may be used to join the outer perimeters of the outer panel 1070 and the inner panel 1086 together. Additionally, the vent panel 1080 is joined to the second panel portion 1046b of the inner panel 1086 by the stitching 942 that creates the seam extending between the first chamber 934a and the second chamber 934b of the second airbag portion 932 (See, e.g., FIG. 9C). As shown in FIG. 10E, the stitching 942 can extend from proximate the outer edge portion of the airbag panels to proximate the fold line 1074. When the outer panel 1070 is joined to the inner panel 1086 as shown in FIG. 10E, the first panel portions 1044a and 1046a at least partially form the first airbag portion 930, and the second panel portions 1044b and 1046b at least partially form the second airbag portion 932.

Referring next to FIG. 10F, the panel assembly shown in FIG. 10E is folded about the fold line 1074 with the vent panel 1080 positioned on the outer surface of the outer panel 1070. The first and second tethers 936a, 936b (FIG. 9B) are then sewn or otherwise suitably attached to the respective side portions of the first air bag portion 930 and the second airbag portion 932 to hold the two airbag portions together. Additionally, the first internal vent opening 1094a is aligned with the second internal vent opening 1094b, and the third internal vent opening 1094c is aligned with the fourth internal vent opening 1094d, and the airbag material around the perimeters of the respective pairs of aligned openings are joined together with suitable stitching 1095a, b. In the foregoing manner, the internal vent openings 1094 create open passages that allow the internal gas in the airbag 920 to vent between the first airbag portion 930 and the second airbag portion 932. After the foregoing steps, the uninflated airbag 920 can be folded into a compact form and held together by one or more tethers that keep it folded or otherwise retain the airbag in place when mounted to the mounting plate 922 (FIG. 9A). The one or more tethers can be breakaway tethers configured to rupture or otherwise release the airbag upon internal pressurization for deployment.

FIG. 11A is a top view of the airbag 920 when fully inflated, and FIG. 11B is a top view of the airbag 920 shortly thereafter when the vent panel 1080 has been separated from the outer panel 1070 allowing the airbag 920 to rapidly deflate. Referring first to FIG. 11A in conjunction with FIGS. 9A-9C, the electronic assembly 752 (FIG. 9A) has activated the first inflator 742a, which in turn has rapidly inflated the multi-chamber airbag 920 via the first gas hose 724a, causing it to deploy outwardly from the monument 806 in response to a significant dynamic event. In this configuration, the airbag 920 provides a cushioning barrier between the occupant 800 (FIG. 9C) and the monument 806 as described in detail above. Referring next to FIG. 11B, shortly after (e.g., within 100 ms to 180 ms after) the first inflator 742a has been activated and the occupant has impacted the airbag 920, the electronic assembly 752 activates the second inflator 742b to rapidly inflate the second gas hose 724b. Since the distal end portion 1079 of the second gas hose 724b is sandwiched between the outer panel 1070 and the vent panel 1080, the rapid expansion of the distal end portion 1079 drives the vent panel 1080 away from the outer panel 1070 and breaks or otherwise ruptures the stitching (e.g., the single needle chain stitching) 1082 (FIG. 10C) that secures the vent panel 1080 to the outer panel 1070 of the airbag 920. Once the stitching 1082 has been broken, the internal pressure in the airbag 1070 causes at least a portion or the entire seam of stitching 1082 to unravel and release the vent panel 1080 from the outer panel 1070, thereby allowing the airbag 920 to rapidly deflate and prevent or at least reduce the rebound of the occupant 800 away from the airbag 920.

Each of the following patents and patent applications is incorporated herein by reference in its entirety: U.S. patent application Ser. No. 13/174,659, filed Jun. 30, 2011, now U.S. Pat. No. 9,156,558, and titled INFLATABLE PERSONAL RESTRAINT SYSTEMS; U.S. patent application Ser. No. 14/804,916, filed Aug. 31, 2015, and titled INFLATABLE PERSONAL RESTRAINT SYSTEMS; U.S. patent application Ser. No. 09/143,756, filed Aug. 13, 1998, now U.S. Pat. No. 5,984,350, and titled VEHICLE SAFETY SYSTEM; U.S. patent application Ser. No. 10/672,606, filed Sep. 26, 2003, now U.S. Pat. No. 6,957,828, and titled INFLATABLE LAP BELT SAFETY BAG; U.S. patent application Ser. No. 09/253,874, filed Mar. 13, 2000, now U.S. Pat. No. 6,439,600, and titled SELF-CENTERING AIRBAG AND METHOD FOR MANUFACTURING AND TUNING THE SAME; U.S. patent application Ser. No. 09/523,875, filed Mar. 13, 2000, now U.S. Pat. No. 6,535,115, and titled AIR BAG HAVING EXCESSIVE EXTERNAL MAGNETIC FIELD PROTECTION CIRCUITRY; U.S. patent application Ser. No. 09/524,370, filed Mar. 14, 2000, now U.S. Pat. No. 6,217,066, and titled MULTIPLE INFLATOR SAFETY CUSHION; U.S. patent application Ser. No. 12/057,295, filed Mar. 27, 2008, now U.S. Pat. No. 7,665,761, and titled INFLATABLE PERSONAL RESTRAINT SYSTEMS AND ASSOCIATED METHODS OF USE AND MANUFACTURE; U.S. patent application Ser. No. 12/051,768, filed Mar. 19, 2008, now U.S. Pat. No. 7,980,590, and titled INFLATABLE PERSONAL RESTRAINT SYSTEMS HAVING WEB-MOUNTED INFLATORS AND ASSOCIATED METHODS OF USE AND MANUFACTURE; U.S. patent application Ser. No. 13/608,959, filed Sep. 10, 2012, now U.S. Pat. No. 9,176,202, and titled ELECTRONIC MODULE ASSEMBLY FOR INFLATABLE PERSONAL RESTRAINT SYSTEMS AND ASSOCIATED METHODS; U.S. patent application Ser. No. 13/170,079, filed Jun. 27, 2011, now abandoned, and titled SENSORS FOR DETECTING RAPID DECELERATION/ACCELERATION EVENTS; U.S. patent application Ser. No. 13/194,411, filed Jul. 29, 2011, now U.S. Pat. No. 8,439,398, and titled INFLATOR CONNECTORS FOR INFLATABLE PERSONAL RESTRAINTS AND ASSOCIATED SYSTEMS AND METHODS; U.S. patent application Ser. No. 13/227,392, filed Sep. 7, 2011, now U.S. Pat. No. 8,556,293, and titled BUCKLE CONNECTORS FOR INFLATABLE PERSONAL RESTRAINTS AND ASSOCIATED METHODS OF USE AND MANUFACTURE; U.S. patent application Ser. No. 13/086,134, filed Apr. 13, 2011, now U.S. Pat. No. 8,469,397, and titled STITCH PATTERNS FOR RESTRAINT-MOUNTED AIRBAGS AND ASSOCIATED SYSTEMS AND METHODS; U.S. patent application Ser. No. 13/227,382, filed Sep. 7, 2011, now U.S. Pat. No. 8,403,361, and titled ACTIVATION SYSTEMS FOR INFLATABLE PERSONAL RESTRAINT SYSTEMS; U.S. patent application Ser. No. 13/228,333, filed Sep. 8, 2011, now U.S. Pat. No. 8,818,759, and titled COMPUTER SYSTEM FOR REMOTE TESTING OF INFLATABLE PERSONAL RESTRAINT SYSTEMS; U.S. patent application Ser. No. 11/468,170, filed Aug. 25, 2014, now U.S. Pat. No. 9,153,080, and titled COMPUTER SYSTEM FOR REMOTE TESTING OF INFLATABLE PERSONAL RESTRAINT SYSTEMS; U.S. patent application Ser. No. 14/874,694, filed Oct. 5, 2015, and titled COMPUTER SYSTEM FOR REMOTE TESTING OF INFLATABLE PERSONAL RESTRAINT SYSTEMS; U.S. patent application Ser. No. 13/228,362, filed Sep. 8, 2011, now U.S. Pat. No. 8,914,188, and titled COMPUTER SYSTEM AND GRAPHICAL USER INTERFACE FOR TESTING OF INFLATABLE PERSONAL RESTRAINT SYSTEMS; U.S. patent application Ser. No. 13/424,197, filed Mar. 19, 2012, now U.S. Pat. No. 8,523,220, and titled STRUCTURE MOUNTED AIRBAG ASSEMBLIES AND ASSOCIATED SYSTEMS AND METHODS; U.S. patent application Ser. No. 14/384,655, filed Sep. 11, 2014, now U.S. Pat. No. 9,511,866, and titled STRUCTURE MOUNTED AIRBAG ASSEMBLIES AND ASSOCIATED SYSTEMS AND METHODS; U.S. patent application Ser. No. 14/705,915, filed May 6, 2015, and titled STRUCTURE MOUNTED AIRBAG ASSEMBLIES AND ASSOCIATED SYSTEMS AND METHODS; U.S. Provisional Patent Application No. 62,041,549, filed Aug. 25, 2014; U.S. patent application Ser. No. 14/808,983, filed Jul. 24, 2015, and titled AIRBAG ASSEMBLY FOR LEG FLAIL PROTECTION AND ASSOCIATED SYSTEMS AND METHODS; U.S. patent application Ser. No. 14/505,277, filed Oct. 2, 2014, now U.S. Pat. No. 9,352,839, and titled ACTIVE POSITIONING AIRBAG ASSEMBLY AND ASSOCIATED SYSTEMS AND METHODS; U.S. Provisional Patent Application No. 62/139,684, filed Mar. 28, 2015; U.S. patent application Ser. No. 15/079,984, filed Mar. 24, 2016, and titled EXTENDING PASS-THROUGH AIRBAG OCCUPANT RESTRAINT SYSTEMS, AND ASSOCIATED SYSTEMS AND METHODS; U.S. Provisional Patent Application No. 62/146,268, filed Apr. 11, 2015; U.S. patent application Ser. No. 15/096,158, filed Apr. 11, 2016, and titled ACTIVE AIRBAG VENT SYSTEM; U.S. patent application Ser. No. 15/002,237, filed Jan. 20, 2016, and titled OCCUPANT RESTRAINT SYSTEMS HAVING EXTENDING RESTRAINTS, AND ASSOCIATED SYSTEMS AND METHODS; and U.S. Provisional Patent Application No. 62/289,761, filed Feb. 1, 2016, and titled SEAT BELT AIRBAG WITH HEAD PILLOW. Any patents and applications and other references identified herein, including any that may be listed in accompanying filing papers, are incorporated herein by reference in their entirety. Aspects of the invention can be modified, if necessary, to employ the systems, functions, and concepts of the various references described above to provide yet further implementations of the invention.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/we claim:

1. An airbag system for use with a structure positioned in the vicinity of an aircraft seat, the airbag system comprising:
an airbag assembly configured to be mounted to the structure, wherein the airbag assembly includes a multi-chamber airbag having—
a first airbag portion having at least a first chamber; and
a second airbag portion having at least a second chamber separate from the first chamber but in fluid communication with the first chamber, wherein in operation, the first and second airbag portions inflate and deploy generally outward from the structure and toward the aircraft seat, wherein the first airbag portion inflates generally above the second airbag portion, and wherein the second airbag portion extends further toward the aircraft seat than the first airbag portion.

2. The airbag system of claim 1 wherein the second airbag portion includes a third chamber separate from the first and second chambers but in fluid communication with the first and second chambers, and wherein the second and third chambers inflate side-by-side.

3. The airbag system of claim 1 wherein the first airbag portion includes only the first chamber, the first chamber having a first width, and wherein the second airbag portion includes a third chamber separate from the first and second chambers but in fluid communication with the first and second chambers, wherein the second and third chambers inflate side-by-side and together have a second width that is approximately equal to the first width.

4. The airbag system of claim 1 wherein the multi-chamber airbag further includes an active vent, and wherein the airbag system further includes:
a first inflator in fluid communication with the multi-chamber airbag; and
a second inflator operably connected to the active vent via a gas hose, wherein in operation, the first inflator is configured to rapidly inflate the first and second airbag portions in response to a dynamic event above a preset magnitude, and wherein the second inflator is configured to subsequently inflate the gas hose and open the active vent to rapidly deflate the first and second airbag portions.

5. An airbag assembly configured to protect an occupant seated in an aircraft seat in the event of an accident or other significant dynamic event, the airbag assembly comprising:
a first airbag portion having at least a first chamber;
a second airbag portion having second and third chambers in fluid communication with the first chamber, wherein the second and third chambers are configured to inflate side-by-side and the first chamber is configured to inflate adjacent to the second and third chambers;
an active vent operably coupled to at least one of the first or second airbag portions;
a first inflator;
a second inflator;
a first gas hose having a first end portion operably coupled to the first inflator and a second end portion in fluid communication with the first, second, and third chambers; and
a second gas hose having a first end portion operably coupled to the second inflator and a second end portion operably coupled to the active vent, wherein the first inflator is configured to rapidly inflate the first and second airbag portions via the first gas hose in response to a first signal, and wherein the second inflator is configured to rapidly inflate the second gas hose and activate the active vent in response to a second signal, after the first signal.

6. The airbag assembly of claim 5:
wherein at least one of the first or second airbag portions includes an exterior panel having an opening therein,
wherein the active vent includes a vent panel releasably attached to the exterior panel to at least partially cover the opening therein, and
wherein rapid inflation of the second gas hose in response to the second signal causes the vent panel to at least partially separate from the exterior panel and enable rapid deflation of the first and second airbag portions via the opening.

7. The airbag assembly of claim 5:
wherein at least one of the first or second airbag portions includes an exterior panel having an opening therein,
wherein the active vent includes a vent panel releasably attached to the exterior panel to at least partially cover the opening therein,
wherein the second end portion of the second gas hose is operably sandwiched between a portion of the exterior panel and a portion of the vent panel, and
wherein rapid inflation of the second gas hose in response to the second signal causes the vent panel to at least partially separate from the exterior panel and enable rapid deflation of the first and second airbag portions via the opening.

8. The airbag assembly of claim 5:
wherein at least one of the first or second airbag portions includes an exterior panel having an opening therein,
wherein the active vent includes a vent panel having a perimeter portion releasably attached to the exterior panel with stitching to at least partially cover the opening therein,
wherein the second end portion of the second gas hose is operably sandwiched between a portion of the exterior panel and the perimeter portion of the vent panel, and
wherein rapid inflation of the second gas hose in response to the second signal ruptures the stitching, thereby enabling the vent panel to at least partially separate from the exterior panel for rapid deflation of the first and second airbag portions via the opening.

9. The airbag assembly of claim 8 wherein the perimeter portion of the vent panel is releasably attached to the exterior panel with a single needle chain stitch.
